(19) United States
(12) Patent Application Publication
(10) Pub. No.: US 2025/0015392 A1
(43) Pub. Date: Jan. 9, 2025

(54) MATERIALS, SYSTEMS, AND METHODS INCORPORATING AN INSULATION LAYER INTO THE ENCAPSULATING LAYER OF A POUCH CELL

(71) Applicant: Aspen Aerogels, Inc., Northborough, MA (US)

(72) Inventor: Younggyu Nam, Medford, MA (US)

(21) Appl. No.: 18/699,793

(22) PCT Filed: Mar. 3, 2023
(86) PCT No.: PCT/US2023/063656

§ 371 Date: Apr. 9, 2024

Related U.S. Application Data
(60) Provisional application No. 63/316,497, filed on Mar. 4, 2022.

(51) Int. Cl. H01M 10/658; H01M 10/0525; H01M 50/105; H01M 50/119; H01M 50/121; H01M 50/124; H01M 50/133; H01M 50/46

(52) U.S. Cl. CPC H01M 10/658; H01M 10/0525; H01M 50/105; H01M 50/119; H01M 50/121; H01M 50/124; H01M 50/133; H01M 50/46

(57) ABSTRACT

The present disclosure relates to materials and systems to manage thermal runaway issues in energy storage systems. Exemplary embodiments include an insulation layer that is placed in the encapsulation material used to encapsulate a pouch battery cell. The encapsulation layer for a pouch battery cell is made from a laminate film that comprises an insulation layer.

### CROSS-REFERENCE TO RELATED APPLICATIONS

This application claims priority to U.S. Provisional Application Ser. No. 63/316,497 entitled “MATERIALS, SYSTEMS, AND METHODS INCORPORATING AN INSULATION LAYER INTO THE ENCAPSULATING LAYER OF A POUCH CELL” filed Mar. 4, 2022, which is incorporated herein by reference in its entirety.

### FIELD OF THE TECHNOLOGY

The present disclosure relates generally to materials, systems, and methods incorporating an insulation layer into the encapsulating layer of a pouch cell. The present disclosure further relates to a battery module or battery pack with one or more battery cells that have an insulation layer in the encapsulating layer of a pouch cell.

### BACKGROUND

Rechargeable batteries such as lithium-ion batteries have found wide application in the power-driven and energy storage systems. Lithium-ion batteries (LIBs) are widely used in powering portable electronic devices such as cell phones, tablets, laptops, power tools and other high-current devices such as electric vehicles because of their high working voltage, low memory effects, and high energy density compared to traditional batteries. However, safety is a concern as LIBs are susceptible to catastrophic failure under “abuse conditions” such as when a rechargeable battery is overcharged (being charged beyond the designed voltage), over-discharged, or operated at or exposed to high temperature and high pressure. As a consequence, narrow operational temperature ranges and charge/discharge rates are limitations on the use of LIBs, as LIBs may fail through a rapid self-heating or thermal runaway event when subjected to conditions outside of their design window.

Thermal runaway may occur when the internal reaction rate increases to the point that more heat is being generated than can be withdrawn, leading to a further increase in both reaction rate and heat generation. During thermal runaway, high temperatures trigger a chain of exothermic reactions in a battery, causing the battery's temperature to increase rapidly. In many cases, when thermal runaway occurs in one battery cell, the generated heat quickly heats up the cells in close proximity to the cell experiencing thermal runaway. Each cell that is added to a thermal runaway reaction contains additional energy to continue the reactions, causing thermal runaway propagation within the battery pack, eventually leading to a catastrophe with fire or explosion. Prompt heat dissipation and effective block of heat transfer paths can be effective countermeasures to reduce the hazard caused by thermal runaway propagation.

Based on the understanding of the mechanisms leading to battery thermal runaway, many approaches are being studied, with the aim of reducing safety hazards through the rational design of battery components. To prevent such cascading thermal runaway events from occurring, LIBs are typically designed to either keep the energy stored sufficiently low or employ enough insulation material between cells within the battery module or pack to insulate them from thermal events that may occur in an adjacent cell, or a combination thereof. The former severely limits the amount of energy that could potentially be stored in such a device. The latter limits how close cells can be placed and thereby limits the effective energy density.

There are currently a number of different methodologies employed to maximize energy density while guarding against cascading thermal runaway. One approach is to incorporate a sufficient amount of insulation between cells or clusters of cells. This approach is generally thought to be desired from a safety vantage; however, in this approach the ability of the insulating material to contain the heat, combined with the volume of insulation required dictate the upper limits of the energy density that can be achieved.

Another approach is through the use of phase change materials. These materials undergo an endothermic phase change upon reaching a certain elevated temperature. The endothermic phase change absorbs a portion of the heat being generated and thereby cools the localized region. Typically, for electrical storage devices these phase change materials rely on hydrocarbon materials such as waxes and fatty acids for example. These systems are effective at cooling, but are themselves combustible and therefore are not beneficial in preventing thermal runaway once ignition within the storage device does occur.

Incorporation of intumescent materials is another strategy for preventing cascading thermal runaway. These materials expand above a specified temperature producing a char that is designed to be lightweight and provide thermal insulation when needed. These materials can be effective in providing insulating benefits, but the expansion of the material must be accounted for in the design of the storage device.

Aerogel materials have also been used as thermal barrier materials. Aerogel thermal barriers offer numerous advantages over other thermal barrier materials. Some of these benefits include favorable resistance to heat propagation and fire propagation while minimizing thickness and weight of materials used. Aerogel thermal barriers also have favorable properties for compressibility, compressional resilience, and compliance. Some aerogel based thermal barriers, due to their light weight and low stiffness, can be difficult to install between battery cells, particularly in a mass production setting. Furthermore, aerogel thermal barriers tend to produce particulate matter (dust) that can be detrimental to the electrical storage systems, creating manufacturing problems.

### SUMMARY

It is an object of the present disclosure to obviate or mitigate at least one disadvantage of previous methods and materials mentioned above. The use of insulation layers in the encapsulation material of a pouch battery cell reduces problems associated with overheating and thermal runaway of battery cells.

Example 1 of the present disclosure includes a battery cell comprises battery cell components. The battery cell components comprise: one or more cathodes; one or more anodes; and one or more separators positioned between the one or more cathodes and the one or more anode. The battery cell further comprises an encapsulation material surrounding the battery cell components. The encapsulation layer comprises an insulation layer. The battery cell, in some aspects may be a lithium-ion battery cell.

Example 2 includes the subject matter of Example 1, wherein the encapsulation material of a battery cell comprises a laminate film comprising an inner polymer layer and an insulation layer positioned on the inner polymer layer. The inner polymer layer is in contact with the battery cell components.

Example 3 includes the subject matter of Example 1 or Example 2, wherein the encapsulation material comprises a laminate film comprising an inner polymer layer, an insulation layer in contact with the inner polymer layer, and an outer polymer layer in contact with the insulation layer. The inner polymer layer is in contact with the battery cell components and the insulation layer is positioned between the inner polymer layer and the outer polymer layer.

Example 4 includes the subject matter of any of the preceding examples, wherein the encapsulation material comprises a laminate film comprising an inner polymer layer, an insulation layer in contact with the inner polymer layer, a malleable layer comprising a malleable material in contact with the insulation layer, and an outer polymer layer in contact with the malleable layer. The inner polymer layer is in contact with the battery cell components, the insulation layer is positioned between the inner polymer layer and the malleable layer, and the malleable layer is positioned between the insulation layer and the outer polymer layer.

Example 5 includes the subject matter of any of the preceding examples, wherein the encapsulation material comprises a laminate film comprising an inner polymer layer, a malleable layer comprising a malleable material in contact with the inner polymer layer, an insulation layer in contact with the malleable layer, and an outer polymer layer in contact with the insulation layer. The inner polymer layer is in contact with the battery cell components, the malleable layer is positioned between the inner polymer layer and the insulation layer, and the insulation layer is positioned between the malleable layer and the outer polymer layer.

Example 6 includes the subject matter of any of the preceding examples, wherein the encapsulation material comprises a laminate film comprising an inner polymer layer, a malleable layer comprising a malleable material in contact with the inner polymer layer, an outer polymer layer in contact with the malleable layer, and an insulation layer in contact with the outer polymer layer. The inner polymer layer is in contact with the battery cell components, the malleable layer is positioned between the inner polymer layer and the outer polymer layer, and the outer polymer layer is positioned between the malleable layer and the insulation layer.

Example 7 includes the subject matter of any of the preceding examples, wherein the outer polymer layer comprises a polymer that is resistant to dielectric heat transfer fluids in the electrical energy storage system. For example, the outer polymer layer comprises a polymer that is resistant to a heat transfer fluid selected from the group consisting of hydrocarbon fluids, ester fluids, silicone fluids, fluoroether fluids, and combinations thereof. In one aspect of the present disclosure, the outer polymer layer is made from a polymer selected from the group consisting of polyoxymethylene, acrylonitrile butadiene styrene, polyamide-imide, polyamide, polycarbonate, polyester, polyetherimide, polystyrene, polysulfone, polyimide, and terephthalate. In a specific aspect of the invention, the outer polymer layer is composed of polyethylene terephthalate (“PET”) or oriented nylon (“ONy”), and the inner polymer layer is composed of polypropylene (“PP”).

Example 8 includes the subject matter of any of the preceding examples, wherein the inner polymer layer comprises a polymer that can be heat welded to itself. For example, the inner polymer layer comprises a polyolefin polymer. In some aspects, the inner polymer is composed of a polymer that is different from the polymer in the outer polymer layer.

Example 9 includes the subject matter of any of the preceding examples, wherein the malleable layer comprises, in some aspects a metal foil. In some aspects, the malleable layer comprises a malleable polymer.

Example 10 includes the subject matter of any of the preceding examples, wherein, the encapsulation layer further comprises an adhesive disposed between the outer polymer layer and the malleable layer and/or the inner polymer layer and the malleable layer.

Example 11 includes the subject matter of any of the preceding examples, wherein, the outer polymer layer has a thickness of about 10 μm to about 100 μm. In an aspect of the disclosure, the malleable layer has a thickness of about 10 μm to about 100 μm. In an aspect of the disclosure, the inner polymer layer has a thickness of about 10 μm to about 100 μm.

Example 12 includes the subject matter of any of the preceding examples, wherein, the insulation layer has a thermal conductivity through a thickness dimension of said insulation layer of less than about 50 mW/m-K at 25° C, and less than about 60 mW/m-K at 600° C. In an aspect of the disclosure, the insulation layer comprises an aerogel.

Example includes a battery module that comprises a plurality of battery cells having an encapsulation layer that comprises an insulation layer, as described herein, and that includes the subject matter of any of the preceding Examples.

In another aspect, provided herein is a device or vehicle including the battery module or pack according to any one of the above Examples. In some embodiments, said device is a laptop computer, PDA, mobile phone, tag scanner, audio device, video device, display panel, video camera, digital camera, desktop computers military portable computers military phones laser range finders digital communication device, intelligence gathering sensor, electronically integrated apparel, night vision equipment, power tool, calculator, radio, remote controlled appliance, GPS device, handheld and portable television, car starters, flashlights, acoustic devices, portable heating device, portable vacuum cleaner or a portable medical tool. In some embodiments, the vehicle is an electric vehicle.

The use of an insulation layer in the encapsulation material of a battery cell, as described herein and including the subject matter of any of the preceding Examples, can provide one or more advantages over existing thermal runaway mitigation strategies. The insulation layer can minimize or eliminate cell thermal runaway propagation without significantly impacting the energy density of the battery module or pack and assembly cost. The insulation layer can also provide favorable properties for compressibility, compressional resilience, and compliance to accommodate swelling of the battery cells that continues during the life of the cell while possessing favorable thermal properties under normal operation conditions as well as under thermal runaway conditions. The insulation layers have favorable resistance to heat propagation and fire propagation while minimizing thickness and weight of materials used.

### BRIEF DESCRIPTION OF THE DRAWINGS

Having thus described the disclosure in general terms, reference will now be made to the accompanying drawings, which are not necessarily drawn to scale, and wherein:

FIG. 1 depicts a schematic diagram of a pouch battery cell;

FIG. 2 depicts a cross-sectional view of a typical laminate film used to encapsulate battery cell components;

FIG. 3A depicts a top view of battery components encapsulated by a laminate film.

FIG. 3B depicts a cross-sectional view of a laminate film used to encapsulate battery cell components having an external insulation layer.

FIG. 4 depicts a cross-sectional view of a laminate film used to encapsulate battery cell components having an insulation layer surrounded by an inner polymer layer and an outer polymer layer.

FIG. 5 depicts a cross-sectional view of a laminate film used to encapsulate battery cell components having a malleable layer and an insulation layer surrounded by an inner polymer layer and an outer polymer layer.

FIG. 6 depicts a cross-sectional view of a laminate film used to encapsulate battery cell components having a malleable layer and an insulation layer surrounded by an inner polymer layer and an outer polymer layer, with the insulation layer disposed between the malleable layer and the outer polymer layer.

FIG. 7 depicts a cross-sectional view of a laminate film used to encapsulate battery cell components having a malleable layer surrounded by an inner polymer layer and an outer polymer layer, with an external insulation layer disposed between the malleable layer and the outer polymer layer.

FIG. 8 depicts a schematic diagram of a battery module.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION

In the following detailed description of the preferred embodiments, reference is made to the accompanying drawings, which form a part thereof, and within which are shown by way of illustration specific embodiments by which the disclosure may be practiced. It is to be understood that other embodiments may be utilized and structural changes may be made without departing from the scope of the disclosure.

One of the most common types of batteries in use today is a lithium-ion battery cell. A lithium-ion battery cell typically includes a cathode composed of carbon (e.g., graphite) and an anode composed of lithium. A non-aqueous electrolyte is used and typically includes lithium salts. A polymeric separator is used to separate the anode from the cathode.

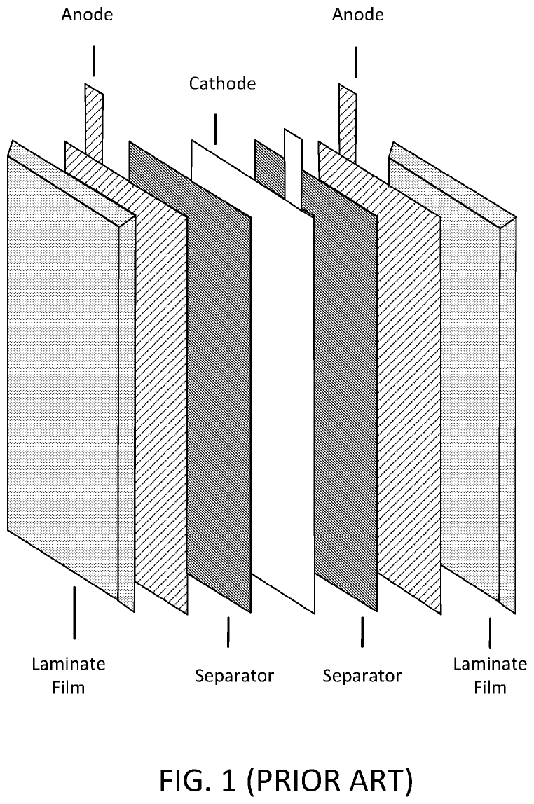

FIG. 1 depicts a schematic diagram of a typical pouch battery cell (e.g., a lithium pouch battery cell). Pouch battery cells are composed of one or more cathodes and one or more anodes. The one or more cathodes and anodes are usually in the form of a sheet. The cathodes and anodes are separated from each other by a separator. An electrolyte composition is disposed between the cathode(s) and the anode(s). The cathode(s), anode(s), electrolyte composition and separators and other parts such as current collectors and tabs will, herein, collectively be referred to as the “battery cell components.” In a pouch cell battery, the battery cell components are encapsulated in a flexible laminate film, as shown in FIG. 1. It should be understood that FIG. 1 is intended for illustration purposes only and the number of cathodes and anodes can vary depending on the intended use of the battery cell and the type of chemistry being used to generate electrical power.

Pouch battery cells offer a number of advantages over prismatic type batteries, which use a hard aluminum or stainless steel case to enclose the chemical components. Some of the advantages of pouch battery cells is that the weight can be lighter, and pouch battery cells can be easily made into different sizes and shapes.

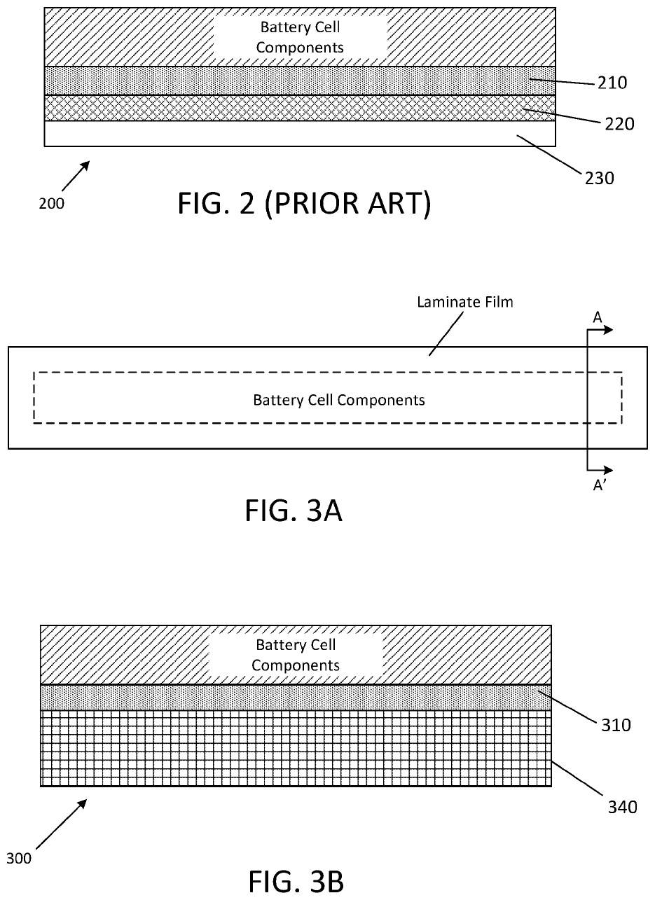

FIG. 2A depicts a cross-sectional view of a typical laminate film 200 used to encapsulate the battery cell components (e.g., a pouch battery cell as depicted in FIG. 1). The laminate film includes an inner polymer layer 210, a metal foil layer 220 (typically aluminum), and an outer polymer layer 230. Inner polymer layer is typically formed from a polymer that is resistant to the chemical components of the pouch battery cell (e.g., the battery cell electrolyte). Metal foil layer is used to protect the battery cell from moisture and air. The metal foil layer can also be molded into a compartment to hold the battery cell components. The outer polymer layer is used to protect the battery cell from external fluids and impacts, ruptures and scratches.

The present disclosure is directed to a pouch battery cell that includes an insulation layer in the encapsulating material that surrounds the battery cell components. The insulation layer, incorporated into the encapsulating material of the pouch battery cell will help prevent or inhibit transfer of heat and heated particles to nearby battery cells during a thermal runaway event.

FIG. 3A depicts a top view of battery cell components encapsulated by a laminate film 300. The indicated cross-section A-A′ in FIG. 3A represents the location of the cross-section view that is used in the various examples of the encapsulated battery cell components shown in FIGS. 3B, 4, 5, 6, and 7. Furthermore, for clarity, the cross-sectional views shown in FIGS. 3B, 4, 5, 6, and 7 depicts only a portion of the cross-sectional view. The portion shown encompasses battery cell components and only one layer of the laminate film that encapsulates the battery cell. This view is not specifically indicated in the subsequent figures for brevity and convenience. FIG. 3B depicts a cross-sectional view (A-A′) of an embodiment of a pouch battery cell laminate film 300. Pouch battery cell laminate film 300 is composed of an inner polymer layer 310 and an insulation layer 340 positioned on the inner polymer layer. The inner polymer layer is in contact with at least one of the battery cell components.

Adding an insulation layer to the encapsulation material of a battery cell can help mitigate problems associated with excessive heating and thermal runaway of battery cells. An insulation layer may include any kind of insulation layer commonly used to separate battery cells or battery modules. Exemplary insulation layers include, but are not limited to, polymer based thermal barriers (e.g., polypropylene, polyester, polyimide, and aromatic polyamide (aramid)), phase change materials, intumescent materials, aerogel materials, mineral based barrier (e.g., mica), and inorganic thermal barriers (e.g., fiberglass containing barriers). The insulation layer may be encapsulated in a single polymer film or a laminate polymer film, as discussed in U.S. Provisional Patent Application No. 63/304,258 which is incorporated herein by reference.

In a preferred embodiment, the insulation layer comprises an aerogel material. A description of an aerogel insulation layer is described in U.S. Patent Application Publication No. 2021/0167438 and U.S. Provisional Patent Application No. 63/218,205, both of which are incorporated herein by reference.

The insulation layer can have a thermal conductivity through a thickness dimension of said insulation layer about 50 mW/mK or less, about 40 mW/mK or less, about 30 mW/mK or less, about 25 mW/mK or less, about 20 mW/mK or less, about 18 mW/mK or less, about 16 mW/mK or less, about 14 mW/mK or less, about 12 mW/mK or less, about 10 mW/mK or less, about 5 mW/mK or less, or in a range between any two of these values at 25° C. under a load of up to about 5 MPa.

In one aspect, an inner polymer layer comprises a material that can be heat welded to itself. Typically, after encapsulating the battery cell components a portion of the inner polymer layer extends away from the battery cell components. A thermal seal may be formed by applying heat to the inner polymer layer. The applied heat will raise the temperature of the polymer to a point that the inner polymer layer can fuse together to form a sealed pouch enclosing the battery cell components. An exemplary polymer that can be used as the inner polymer layer of the encapsulation material is a polyolefin polymer. Examples of polyolefin polymers that can be used as the inner polymer layer include, but are not limited to, polyethylene and polypropylene.

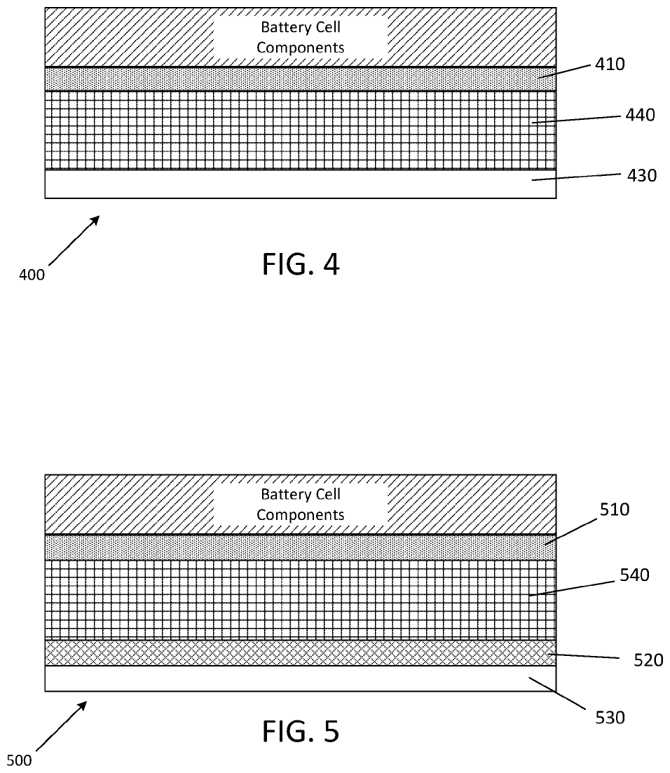

FIG. 4 depicts a cross-sectional view (A-A′) of an alternate embodiment of a pouch battery cell laminate film 400. Pouch battery cell laminate film 400 is composed of an inner polymer layer 410, an insulation layer 440, and an outer polymer layer 430. As depicted in FIG. 4, inner polymer layer 410 is in contact with the battery cell components. Insulation layer 440 is in contact with the inner polymer layer. Outer polymer layer 430 is in contact with the insulation layer. Insulation layer 440 is positioned between inner polymer layer 410 and outer polymer layer 430

Outer polymer layer can provide wear protection to the battery cell. During use, external stress can cause the encapsulation material to be damaged. Damage to the encapsulation material can compromise the battery cell. External stress that can occur to an unprotected battery cell include, but are not limited to, chemical leakage from ruptured battery cells, stress caused by expansion of the battery cells, changes in ambient temperature, external impact, external rupture. and external scratching of the insulation layer. In some aspects of the present disclosure the outer polymer layer is selected from a material that protects the battery cell from external stresses. Exemplary polymers that may be used for the outer polymer layer include, but are not limited to, polyoxymethylene, acrylonitrile butadiene styrene, polyamide-imide, polyamide, polycarbonate, polyester, polyetherimide, polystyrene, polysulfone, polyimide, terephthalate, or combinations thereof. Specific examples of polymers that can be used as the outer polymer layer include, but are not limited to, polyethylene terephthalate (“PET”) and oriented nylon (“ONy”).

It should be understood that while a single outer polymer layer is described above, the outer polymer layer can be composed of two or more polymer layers. When multiple outer polymers layers are used, the additional outer polymer layers may be formed from the same polymer or different polymers. In an aspect of the invention, the outer polymer layer is composed of an ONy polymer layer having an overlying PET polymer layer.

FIG. 5 depicts a cross-sectional view (A-A′) of an alternate embodiment of a pouch battery cell laminate film 500. Pouch battery cell laminate film 500 is composed of an inner polymer layer 510, an insulation layer 540, a malleable layer 520, and an outer polymer layer 530. As depicted in FIG. 5, inner polymer layer 510 is in contact with the battery cell components. Insulation layer 540 is in contact with the inner polymer layer. Malleable layer 520, comprising a malleable material, is in contact with the insulation layer. Outer polymer layer 530 is in contact with the malleable layer. Insulation layer 540 is positioned between inner polymer layer 510 and malleable layer 520. Malleable layer 520 is positioned between insulation layer 540 and outer polymer layer 530. Placing a malleable layer in the encapsulation layer can act as a support which allows the pouch battery cell to be more easily manipulated during manufacturing.

Malleable layers can also provide additional heat and mechanical protection when used in the encapsulation material of a battery cell. During a thermal runaway event, battery cells may heat, causing hot particles and gasses to be ejected from the battery cell. These ejected materials can cause the encapsulation material of nearby pouch battery cells to be compromised, sometimes causing the nearby battery cells to go into a runaway state. A malleable layer can inhibit or prevent particle natter and gasses from damaging the battery cell. The malleable layer can also provide additional protection to the battery cell from moisture and air.

In one aspect, a malleable layer comprises a malleable polymer or a malleable metal foil. Aluminum is the most common metal used in a laminate encapsulation layer, however other malleable metal foils can be used such as stainless steel and copper foils.

Use of metal foils can also add heat transfer properties to the encapsulation material surrounding the battery cell components. When thermal runaway of a battery cells occurs, the battery cell heats to very high temperature. This heat can be radiated to adjacent battery cells, causing an increased chance of the adjacent battery cells entering a runaway state. Use of a metal foil can improve the heat properties of the battery cells by providing a thermally conductive metal foil in the encapsulation material. The heat produced by an adjacent runaway battery cell, or by the affected battery cell, can be transferred to the metal foil layer. The metal foil layer can be connected to a portion of the casing of the battery module (e.g., a cooling plate) that allows the heat to be transferred away from the battery cells through the metal foil.

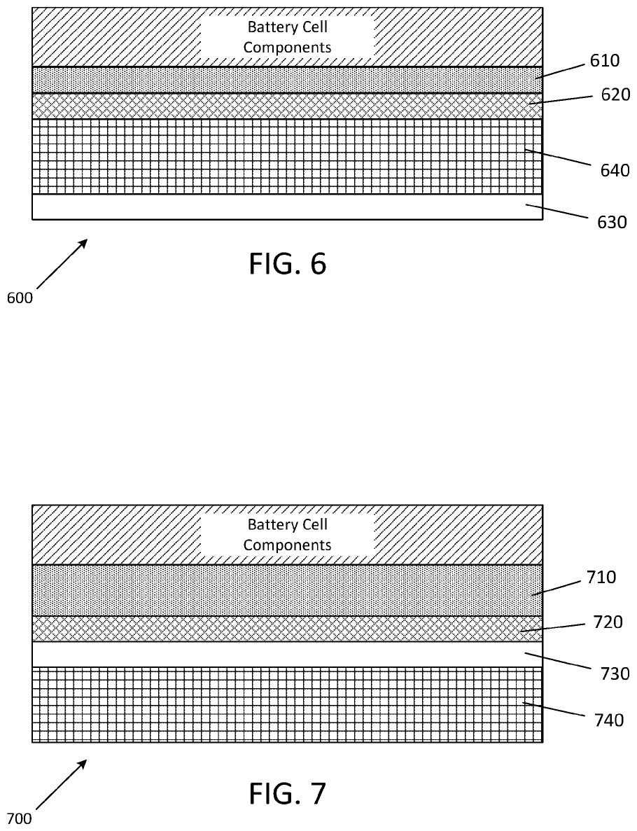

FIG. 6 depicts a cross-sectional view (A-A′) of an alternate embodiment of a pouch battery cell laminate film 600. Pouch battery cell laminate film 600 is composed of an inner polymer layer 610, a malleable layer 620, an insulation layer 640, and an outer polymer layer 630. As depicted in FIG. 6, inner polymer layer 610 is in contact with the battery cell components. Malleable layer 620, comprising a malleable material, is in contact with the inner polymer layer. Insulation layer 640 is in contact with the malleable layer. Outer polymer layer 630 is in contact with the insulation layer. Malleable layer is 620 is positioned between inner polymer layer 610 and insulation layer 640. Insulation layer 640 is positioned between mallcable layer 620 and outer polymer layer 630.

FIG. 7 depicts a cross-sectional view (A-A′) of an alternate embodiment of a pouch battery cell laminate film 700. Pouch battery cell laminate film 700 is composed of an inner polymer layer 710, a malleable layer 720, an outer polymer layer 730, and an insulation layer 740. As depicted in FIG. 7, inner polymer layer 710 is in contact with the battery cell components. Malleable layer 720, comprising a malleable material, is in contact with the inner polymer layer. Outer polymer layer 730 is in contact with the malleable layer. Insulation layer 740 is in contact with the outer polymer layer. Malleable layer 720 is positioned between inner polymer layer 710 and outer polymer layer 730. Outer polymer layer 730 is positioned between malleable layer 720 and insulation layer 740.

The laminate film used as the encapsulation material may be a unitary film composed of multiple layers, as described herein. In an aspect, the laminate film can be formed by placing the malleable layer and insulation layer between the two polymer layers (inner polymer layer and outer polymer layer) and using heat and/or pressure to fuse the inner and outer polymer layer together. In another aspect, an adhesive glue or tape can be used to hold the layers together. For example, adhesives can be disposed between adjacent layers to form the laminate film.

The insulation layer of the present disclosure e.g., an insulation layer including an aerogel, can retain or increase insubstantial amounts in thermal conductivity (commonly measured in mW/m-k) under a load of up to about 5 MPa. In certain embodiments, insulation layer of the present disclosure has a thermal conductivity through a thickness dimension of said insulation layer about 50 mW/mK or less, about 40 mW/mK or less, about 30 mW/mK or less, about 25 mW/mK or less, about 20 mW/mK or less, about 18 mW/mK or less, about 16 mW/mK or less, about 14 mW/mK or less, about 12 mW/mK or less, about 10 mW/mK or less, about 5 mW/mK or less, or in a range between any two of these values at 25° C. under a load of up to about 5 MPa. The thickness of the aerogel insulation layer may be reduced as a result of the load experienced by the aerogel insulation layer. For example, the thickness of the aerogel insulation layer may be reduced by 50% or lower, 40% or lower, 30% or lower, 25% or lower, 20% or lower, 15% or lower, 10% or lower, 5% or lower, or in a range between any two of these values under a load in the range of about 0.50 MPa to 5 MPa. Although the thermal resistance of the insulation layer including an aerogel may be reduced as the thickness is reduced, the thermal conductivity can be retained or increase by insubstantial amounts.

As used in this specification and the appended claims, the singular forms “a”, “an”, and “the” include plural referents unless the content clearly dictates otherwise. As used in this specification and the appended claims, the term “or” is generally employed in its sense including “and/or” unless the context clearly dictates otherwise.

As used herein, “about” means approximately or nearly and in the context of a numerical value or range set forth means +5% of the numerical. In an embodiment, the term “about” can include traditional rounding according to significant figures of the numerical value. In addition, the phrase “about ‘x’ to ‘y’” includes “about ‘x’ to about ‘y’”.

Within the context of the present disclosure, the term “aerogel”, “aerogel material” or “aerogel matrix” refers to a gel comprising a framework of interconnected structures, with a corresponding network of interconnected pores integrated within the framework, and containing gases such as air as a dispersed interstitial medium; and which is characterized by the following physical and structural properties (according to Nitrogen Porosimetry Testing) attributable to aerogels: (a) an average pore diameter ranging from about 2 nm to about 100 nm. (b) a porosity of at least 80% or more, and (c) a surface area of about 100 m²/g or more.

Aerogel materials of the present disclosure thus include any aerogels or other open-celled materials which satisfy the defining elements set forth in previous paragraphs; including materials which can be otherwise categorized as xerogels, cryogels, ambigels, microporous materials, and the like.

Within the context of the present disclosure, references to “thermal runaway” generally refer to the sudden, rapid increase in cell temperature and pressure due various operational factors and which in turn can lead to propagation of excessive temperature throughout an associated module. Potential causes for thermal runaway in such systems may, for example, include: cell defects and/or short circuits (both internal and external), overcharge, cell puncture or rupture such as in the event of an accident, and excessive ambient temperatures (e.g., temperatures typically greater than 55° C.). In normal usc, the cells heat as result of internal resistance. Under normal power/current loads and ambient operating conditions, the temperature within most Li-ion cells can be relatively easily controlled to remain in a range of 20° C. to 55° C. However, stressful conditions such as high power draw at high cell/ambient temperatures, as well as defects in individual cells, may steeply increase local heat generation. In particular, above the critical temperature, exothermic chemical reactions within the cell are activated. Moreover, chemical heat generation typically increases exponential with temperature. As a result, heat generation becomes much greater than available heat dissipation. Thermal runaway can lead to cell venting and internal temperatures in excess of 200° C.

Within the context of the present disclosure, the terms “thermal conductivity” and “TC” refer to a measurement of the ability of a material or composition to transfer heat between two surfaces on either side of the material or composition, with a temperature difference between the two surfaces. Thermal conductivity is specifically measured as the heat energy transferred per unit time and per unit surface area, divided by the temperature difference. It is typically recorded in SI units as mW/m*K (milliwatts per meter*Kelvin). The thermal conductivity of a material may be determined by test methods known in the art, including, but not limited to Test Method for Steady-State Thermal Transmission Properties by Means of the Heat Flow Meter Apparatus (ASTM C518, ASTM International, West Conshohocken, PA); a Test Method for Steady-State Heat Flux Measurements and Thermal Transmission Properties by Means of the Guarded-Hot-Plate Apparatus (ASTM C177. ASTM International, West Conshohocken, PA); a Test Method for Steady-State Heat Transfer Properties of Pipe Insulation (ASTM C335, ASTM International. West Conshohocken, PA); a Thin Heater Thermal Conductivity Test (ASTM C1114, ASTM International, West Conshohocken, PA); Standard Test Method for Thermal Transmission Properties of Thermally Conductive Electrical Insulation Materials (ASTM D5470, ASTM International, West Conshohocken, PA); Determination of thermal resistance by means of guarded hot plate and heat flow meter methods (EN 12667, British Standards Institution, United Kingdom); or Determination of steady-state thermal resistance and related properties-Guarded hot plate apparatus (ISO 8203, International Organization for Standardization, Switzerland). Due to different methods possibly resulting in different results, it should be understood that within the context of the present disclosure and unless expressly stated otherwise, thermal conductivity measurements are acquired according to ASTM C518 standard (Test Method for Steady-State Thermal Transmission Properties by Means of the Heat Flow Meter Apparatus), at a temperature of about 37.5° C, at atmospheric pressure in ambient environment, and under a compression load of about 2 psi. The measurements reported as per ASTM C518 typically correlate well with any measurements made as per EN 12667 with any relevant adjustment to the compression load.

Thermal conductivity measurements can also be acquired at a temperature of about 10° C, at atmospheric pressure under compression. Thermal conductivity measurements at 10° C, are generally 0.5-0.7 mW/mK lower than corresponding thermal conductivity measurements at 37.5° C. In certain embodiments, the insulation layer of the present disclosure has a thermal conductivity at 10° C. of about 40 mW/mK or less, about 30 mW/mK or less, about 25 mW/mK or less, about 20 mW/mK or less, about 18 mW/mK or less, about 16 mW/mK or less, about 14 mW/mK or less, about 12 mW/mK or less, about 10 mW/mK or less, about 5 mW/mK or less, or in a range between any two of these values.

### Use of the Insulation Barriers within Battery Module or Pack

Lithium-ion batteries (LIBs) are considered to be one of the most important energy storage technologies due to their high working voltage, low memory effects, and high energy density compared to traditional batteries. However, safety concerns are a significant obstacle that hinders large-scale applications of LIBs. Under abuse conditions, exothermic reactions may lead to the release of heat that can trigger subsequent unsafe reactions. The situation worsens, as the released heat from an abused cell can activate a chain of reactions, causing catastrophic thermal runaway.

With continuous improvement of LIBs in energy density, enhancing their safety is becoming increasingly urgent for the development of electrical devices e.g. electrical vehicles. The mechanisms underlying safety issues vary for each different battery chemistry. The present technology focuses on tailoring insulation barrier and corresponding configurations of those tailored barriers to obtain favorable thermal and mechanical properties. The insulation barriers of the present technology provide effective heat dissipation strategics under normal as well as thermal runaway conditions, while ensuring stability of the LIB under normal operating modes (e.g., withstanding applied compressive stresses).

The insulation barriers disclosed herein are useful for separating, insulating and protecting battery cells or battery components of batteries of any configuration, e.g., pouch cells, cylindrical cells, prismatic cells, as well as packs and modules incorporating or including any such cells. The insulation barriers disclosed herein are useful in rechargeable batteries e.g. lithium-ion batteries, solid state batteries, and any other energy storage device or technology in which separation, insulation, and protection are necessary.

Passive devices such as cooling systems may be used in conjunction with the insulation barriers of the present disclosure within the battery module or battery pack.

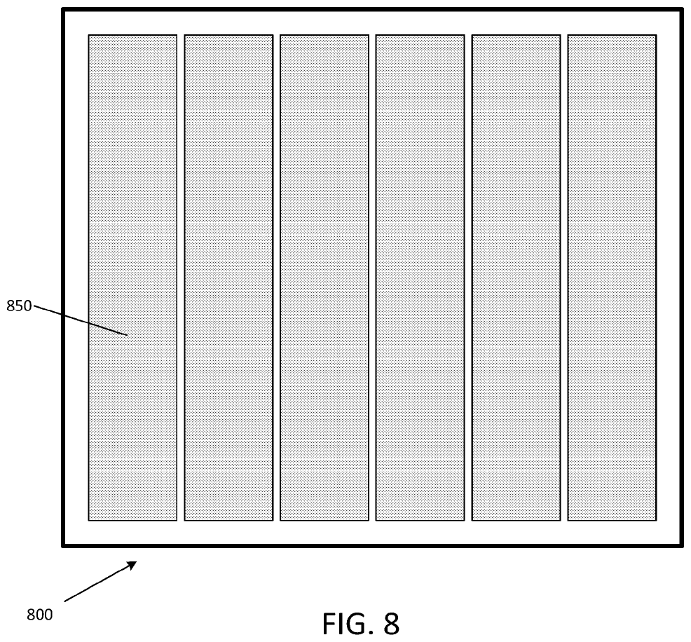

The insulation barrier according to various embodiments of the present disclosure in a battery pack including a plurality of single battery cells or of modules of battery cells for separating said single battery cells or modules of battery cells thermally from one another. A battery module is composed of multiple battery cells disposed in a single enclosure. A battery pack is composed of multiple battery modules. FIG. 8 depicts an embodiment of a battery module 800 having a plurality of battery cells 850. The encapsulated battery cells 850 include an insulation material built into the encapsulation material. The insulation layer in the encapsulation material can inhibit or prevent damage of adjacent battery cells when a battery cell undergoes thermal runaway or any other catastrophic battery cell failure. Incorporating an insulation layer into the encapsulation material may allow a battery module to be assembled without the need for an insulation barrier between battery cells. Alternatively, insulation barriers can be placed between battery cells that include an insulation material in the encapsulation material.

Battery modules and battery packs can be used to supply electrical energy to a device or vehicles. Device that use battery modules or battery packs include, but are not limited to, a laptop computer, PDA, mobile phone, tag scanner, audio device, video device, display panel, video camera, digital camera, desktop computers military portable computers military phones laser range finders digital communication device, intelligence gathering sensor, electronically integrated apparcl, night vision equipment, power tool, calculator, radio, remote controlled appliance, GPS device, handheld and portable television, car starters, flashlights, acoustic devices, portable heating device, portable vacuum cleaner or a portable medical tool. When used in a vehicle, a battery pack can be used for an all-electric vehicle, or in a hybrid vehicle.

In this patent, certain U.S. patents. U.S. patent applications, and other materials (e.g., articles) have been incorporated by reference. The text of such U.S. patents. U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A battery cell comprising:
battery cell components, the battery cell components comprising:
one or more cathodes;
one or more anodes;
one or more separators positioned between the one or more cathodes and the one or more anode; and
an encapsulation material arranged to enclose the battery cell components, the encapsulation material including a laminate film comprising:
an inner polymer layer arranged to at least partially contact the battery cell components and provide chemical resistance therefrom; and
an insulation layer enclosing the inner polymer layer, the insulation layer to impede heat transfer of contents enclosed therein.

2. The battery cell of claim 1, wherein the encapsulation material comprises a laminate film comprising an inner polymer layer and an insulation layer positioned on the inner polymer layer, wherein the inner polymer layer is in contact with the battery cell components.

3. The battery cell of claim 1, wherein the encapsulation material comprises a laminate film comprising an inner polymer layer, an insulation layer in contact with the inner polymer layer, and an outer polymer layer in contact with the insulation layer, wherein the inner polymer layer is in contact with the battery cell components, wherein the insulation layer is positioned between the inner polymer layer and the outer polymer layer, and wherein the outer polymer layer is to protect the battery cell from external fluids and impacts, ruptures or scratches.

4. The battery cell of claim 1, wherein the encapsulation material comprises a laminate film comprising an inner polymer layer, an insulation layer in contact with the inner polymer layer, a malleable layer comprising a malleable material in contact with the insulation layer, and an outer polymer layer in contact with the malleable layer, wherein the inner polymer layer is in contact with the battery cell components, and wherein the insulation layer is positioned between the inner polymer layer and the malleable layer, and wherein the malleable layer is positioned between the insulation layer and the outer polymer layer-, wherein the malleable layer protects the battery cell from moisture and air.

5. The battery cell of claim 1, wherein the encapsulation material comprises a laminate film comprising an inner polymer layer, a malleable layer comprising a malleable material in contact with the inner polymer layer, an insulation layer in contact with the malleable layer, and an outer polymer layer in contact with the insulation layer, wherein the inner polymer layer is in contact with the battery cell components, and wherein the malleable layer is positioned between the inner polymer layer and the insulation layer, and wherein the insulation layer is positioned between the malleable layer and the outer polymer layer.

6. The battery cell of claim 1, wherein the encapsulation material comprises a laminate film comprising an inner polymer layer, a malleable layer comprising a malleable material in contact with the inner polymer layer, an outer polymer layer in contact with the malleable layer, and an insulation layer in contact with the outer polymer layer, wherein the inner polymer layer is in contact with the battery cell components, and wherein the malleable layer is positioned between the inner polymer layer and the outer polymer layer, and wherein the outer polymer layer is positioned between the malleable layer and the insulation layer.

7. The battery cell of claim 1, wherein the battery cell is a lithium-ion battery cell.

8. The battery cell of claim 1, comprising an outer polymer layer made from a polymer selected from the group consisting of polyoxymethylene, acrylonitrile butadiene styrene, polyamide-imide, polyamide, polycarbonate, polyester, polyetherimide, polystyrene, polysulfone, polyimide, and terephthalate.

9. The battery cell of claim 1, wherein the inner polymer layer is composed of a polyolefin polymer.

10. The battery cell of claim 1, wherein the inner polymer layer is composed of a polymer that is different from the polymer in an outer polymer layer included in the battery cell.

11. The battery cell of claim 10, wherein the outer polymer layer is composed of polyethylene terephthalate (“PET”) or oriented nylon (“ONy”), and wherein the inner polymer layer is composed of polypropylene (“PP”).

12. The battery cell of claim 10, wherein the outer polymer layer is composed of a first polymer film composed of a first material and a second polymer film composed of a second material, wherein the first material is different from the second material.

13. The battery cell of claim 1, comprising a malleable layer including a metal foil.

14. The battery cell of claim 1, comprising a malleable layer including a malleable polymer.

15. The battery cell of claim 1, wherein the encapsulation material further comprises an adhesive disposed between layers.

16-18. (canceled)

19. The battery cell of claim 1, wherein the insulation layer has a thermal conductivity through a thickness dimension of said insulation layer of less than about 50 mW/m-K at 25° C, and less than about 60 mW/m-K at 600° C.

20. The battery cell of claim 1, wherein the insulation layer comprises an aerogel.

21. The battery cell of claim 1, wherein the encapsulation material is composed of two laminate films heat welded together.

22. A battery module comprising a plurality of battery cells according to claim 1.

23. (canceled)

24. A device or vehicle comprising a battery module according to claim 22.

25-26. (canceled)
